(19) United States
(12) Patent Application Publication
(10) Pub. No.: US 2025/0162470 A1
(43) Pub. Date: May 22, 2025

(54) VEHICLE SYSTEM ARRANGEMENT

(71) Applicant: HELLA GMBH & CO. KGAA, Lippstadt (DE)

(72) Inventors: Steffen Hoppe, Lippstadt (DE); Stefan Peters, Lippstadt (DE); Guillaume Petot, Landisacq (FR)

(21) Appl. No.: 18/948,098

(22) Filed: Nov. 14, 2024

(30) Foreign Application Priority Data
Nov. 17, 2023 (DE) 102023132081.5

(51) Int. Cl. B60N 2/02; G01B 7/00

(52) U.S. Cl. CPC B60N 2/0272; G01B 7/003; B60N 2210/14

(57) ABSTRACT

A vehicle system arrangement is provided. The vehicle system arrangement includes a first body on which a scanning belt with a plurality of scanning elements is fixedly arranged and a second body, which is displaceable in the direction of movement relative to the first body. A linear path sensor is arranged on the second body, which interacts with the scanning belt. The vehicle system arrangement includes an evaluation unit which is designed to determine a linear position of the first body relative to the second body as a function of the sensor signal of the linear path sensor. The linear path sensor is fixedly mounted on the second body in the direction of movement and is displaceably mounted on the second body transversely to the direction of movement.

### CROSS-REFERENCE TO RELATED APPLICATIONS

The present application claims the benefit of German Patent Application No. 10-2023-132-081.5, filed Nov. 17, 2023, the disclosure of which is incorporated by reference.

### BACKGROUND OF THE INVENTION

The invention relates to a vehicle system arrangement having a first body, on which a scanning belt with a plurality of scanning elements is fixedly arranged, a second body, which can be displaced relative to the first body in the direction of movement, wherein a linear path sensor is arranged on the second body, which interacts with the scanning belt, and an evaluation unit, which is designed to determine a linear position of the first body relative to the second body as a function of the sensor signal of the linear path sensor.

An embodiment variant of a linear path sensor is described, for example, in WO2021/156930A1, wherein the linear path sensor interacts with a scanning belt. The scanning belt is mounted on a first body and the linear path sensor is mounted on a second body that can be moved relative to the first body. The scanning belt has a plurality of scanning elements which are scanned by the linear path sensor, wherein the position of the first body receiving the scanning belt relative to the second body receiving the linear path sensor is determined based on this by means of an evaluation unit or an evaluation circuit.

The problem is that displacements transverse to the direction of movement, tilting and twisting of the linear path sensor relative to the scanning belt leads to falsified sensor signals from the linear path sensor. It is also necessary that the air gap between the linear path sensor and the scanning belt is as small as possible and is the same over the entire measuring path.

### SUMMARY OF THE INVENTION

The object of the invention is to provide a vehicle system arrangement by means of which the position of the bodies relative to one another can be reliably determined. This is to be realized in a simple manner. The object is achieved by embodiments of the invention.

According to the invention, the linear path sensor is fixedly mounted on the second body in the direction of movement and is displaceably mounted on the second body transversely to the direction of movement.

The direction of movement corresponds to the longitudinal direction of the scanning belt, wherein the scanning element has a plurality of scanning elements arranged next to one another in the longitudinal direction, which are detected by the linear path sensor. The position of the bodies relative to one another is determined based on the sensor signals from the linear path sensor. The scanning belt preferably has two rows of scanning elements running parallel to one another, wherein the scanning elements of the two rows are arranged offset to one another, i.e. the distances between the scanning elements of a first row and the distances between the scanning elements of a second row are different.

Mounted such that it can be displaced transversely to the direction of movement means, for example, in the vehicle coordinate system, assuming that the direction of movement is aligned in the longitudinal direction of the vehicle, that the linear path sensor is mounted on the second body such that it can be displaced in the vertical direction of the vehicle and/or in the transverse direction of the vehicle.

By mounting the linear path sensor in this manner, the linear path sensor can be moved together with the second body with a high degree of accuracy in the direction of movement, i.e. in the longitudinal direction of the scanning belt, wherein manufacturing tolerances and other deviations, such as deformation of the second body during operation, can be compensated for by the possible displacement of the linear path sensor transverse to the direction of movement. In other words, the linear path sensor is only entrained by the second body in the direction of movement and is decoupled from the second body transversely to the direction of movement and is thus free to move to a certain degree. The displacement of the linear path sensor transverse to the direction of movement is preferably based exclusively on guiding the linear path sensor on the scanning belt. This allows the distance between the linear path sensor and the scanning belt to be reliably maintained.

Preferably, the linear path sensor is connected to the second body via a plug-in connection device, wherein the plug-in direction of the plug-in connection device is oriented transverse to the direction of movement. This makes it easy to provide entrainment of the linear path sensor in the direction of movement and displacement of the linear path sensor transverse to the direction of movement. In a preferred embodiment, the plug-in connection device has a protrusion which is inserted into a corresponding opening, wherein the protrusion is fixedly mounted in the opening in the direction of movement and is displaceable in a first transverse direction aligned transversely to the direction of movement, such that the protrusion bears against the circumferential surface of the opening on both sides in the direction of movement and glides on the circumferential surface of the opening. Additionally or alternatively, the protrusion is preferably mounted so as to be displaceable in a second transverse direction aligned transversely to the direction of movement, such that there is a gap in the second transverse direction between the protrusion and the circumferential surface of the opening. Preferably, the protrusion is provided on the linear path sensor and the opening is provided on the second body. Alternatively, the protrusion can also be provided on the second body and the opening can be provided on the linear path sensor.

As the protrusion is in contact with the circumferential surface of the opening on both sides, a movement of the second body can be transmitted directly to the linear path sensor. Due to the glide-mounted protrusion on the circumferential surface of the opening, wherein the protrusion is only glide-mounted on the portions of the circumferential surface of the opening that act in the direction of movement, it is possible to displace the linear path sensor relative to the second body in the first transverse direction transverse to the direction of movement. The gap between the protrusion and the circumferential surface of the opening allows the linear path sensor to be displaced relative to the second body in the second transverse direction. Viewed in the vehicle coordinate system and assuming that the direction of movement is aligned in the longitudinal direction of the vehicle, the linear path sensor can be displaced in the vertical direction of the vehicle, which corresponds to the first transverse direction, by the glide bearing and in the transverse direction of the vehicle, which corresponds to the second transverse direction, by the gap between the circumferential surface of the opening and the protrusion, in order to compensate for any deviations that occur. The cross directions can also have a different orientation. The only decisive factor is that the transverse directions are aligned at right angles to the direction of movement.

Preferably, a sleeve-like driver element is provided on the second body or on the linear path sensor and is positively connected to the second body or the linear path sensor, wherein the driver element has the opening or forms the protrusion. Depending on whether the protrusion is provided on the second body or on the linear path sensor or whether the opening is provided on the second body or on the linear path sensor, the sleeve-like driver element can be mounted on the second body or on the linear path sensor and have an opening or form the protrusion. The driver element is necessarily positively connected to the second body or the linear path sensor in the direction of movement. In particular, this can be designed in such a manner that the second body or the linear path sensor has a receiving opening into which the sleeve-like driver element is inserted.

In a preferred embodiment, the sleeve-like driver element has a radial protrusion and a latching element, wherein the sleeve-like driver element is arranged in a receiving opening of the second body and is fixed via the radial protrusion and the latching element in the insertion direction, i.e. in the longitudinal direction, of the driver element. The radial protrusion and the latching element are preferably arranged on an outer side of the driver element. The radial protrusion and the latching element are arranged at a distance from one another in the longitudinal direction of the driver element, wherein the distance corresponds to the wall thickness of the second body or the linear path sensor in the region of the receiving opening. The latching element is spring-loaded.

When mounting the driver element, the driver element can be pushed into the receiving opening until the radial protrusion rests against the second body or the linear path sensor, wherein in this position the latching element has already been pushed back during the push-in movement and the latching element has snapped back into place. In this position, the driver element lies in the longitudinal direction with the radial protrusion against a first contact surface of the second body or the linear path sensor and with the latching element against a second contact surface of the second body or the linear path sensor facing away from the first contact surface. This fixes the driver element in both directions in relation to the longitudinal direction of the driver element.

Preferably, the linear path sensor is guided on the scanning belt in the direction of movement. For this purpose, the linear path sensor preferably has two guide elements that engage behind the scanning belt. The fact that the linear path sensor is mounted on the second body such that it can be displaced transversely to the direction of movement and is guided on the scanning belt in the direction of movement, i.e. the linear path sensor is prevented from being displaced transversely to the direction of movement relative to the scanning belt by the guide, means that a predefined position of the linear path sensor relative to the scanning belt can be reliably maintained and thus falsification of the sensor signal of the linear path sensor due to displacement of the linear path sensor relative to the scanning belt can be reliably avoided.

Preferably, the guide elements each have a slope guide surface that tapers towards one another and rests against a slope mating guide surface of the scanning belt. This provides a dovetail-like guide for the linear path sensor on the scanning belt. This makes it easy to provide exact positioning of the linear path sensor relative to the scanning belt transverse to the direction of movement.

In a preferred embodiment, the scanning belt is chamfered on one end face in order to simplify the insertion of the scanning belt into a space between the two guide surfaces.

Preferably, the linear path sensor has a housing with an upper part and a lower part, wherein a circuit board is latched to the lower part and the upper part is latched to the circuit board. For this purpose, the upper part has one or more latching elements, which are designed as spring-loaded latching hooks, for example, and engage behind the circuit board in a mounted state. In the final assembled state, the latching elements are secured against loosening by the lower part, as one portion of the lower part rests against the outside of the latching element. The lower part also comprises one or more latching elements, which are designed as resilient latching hooks. The latching elements of the lower part engage behind the circuit board when mounted and are therefore also positively connected to the circuit board. The circuit board thus forms the basis of the linear path sensor, wherein the upper and lower parts are mounted on the circuit board. In this manner, the linear path sensor can be easily assembled and has a simple design.

In a preferred embodiment, the upper part has a plug, wherein electrical, spring-loaded contact elements are arranged on the upper part for making contact with a respective mating contact of the circuit board. Because the upper part is connected to the circuit board by a latching connection and the electrical contact between the plug and the circuit board is made by spring contact elements, the electrical contact can be easily implemented and the assembly of the linear path sensor simplified. This means that the electrical contact between the contact elements of the plug and the mating contact elements of the circuit board is made automatically by mounting the upper part.

Preferably, the circuit board is positioned relative to the upper part via a plug connection to ensure reliable electrical coupling between the spring contact elements and the mating contacts of the circuit board. The plug connection is provided by at least one pin provided on the upper part, wherein the pin engages in a corresponding opening of the circuit board. Alternatively, the pin can also be provided on the circuit board and the opening can be provided on the upper part.

Preferably, the linear path sensor is an inductive sensor. Alternatively, the linear path sensor can also be a magnetic field sensor, an optical sensor or a sensor based on a different functional principle. Such an inductive sensor has in particular a cursor belt, which forms the scanning belt, with several cursor pads and non-coupling portions arranged between the cursor pads. The cursor pads are preferably arranged in two rows parallel to one another, wherein the distances between the cursor pads of a first row and the distances between the cursor pads of a second row differ from one another. The cursor pads serve as inductive coupling regions for stators of the linear path sensor, wherein one stator is provided for each row. The stators each have an excitation coil and a sensor coil set, which are arranged on or in the respective stator, which are provided on the circuit board in the present case, in a manner known to the person skilled in the art. The position of the second body relative to the first body is determined from the sensor signals of the linear path sensor using the known vernier principle.

In a preferred embodiment, the first body is a fixed vehicle seat guide rail and the second body is a vehicle seat counter-guide rail connected to the vehicle seat and movable together with the vehicle seat. The linear path sensor and the scanning belt are thus used to determine the position of an adjustable vehicle seat. The vehicle seat guide rail and the vehicle seat counter-guide rail are usually exposed to a wide variety of loads and inevitably have certain manufacturing and assembly tolerances due to their design. The structure of the vehicle system arrangement described in the previous paragraphs is therefore particularly advantageous for use in vehicle seat guidance systems.

### BRIEF DESCRIPTION OF THE DRAWINGS

The invention is explained in more detail in the attached drawings. In the figures:

FIG. 1 shows a schematic longitudinal section of a vehicle system arrangement according to the invention;

FIG. 2 shows a schematic cross-section of the vehicle system arrangement in FIG. 1; and

FIG. 3 shows a schematic top view of a scanning belt of the vehicle system arrangement from FIG. 1 and FIG. 2.

### DETAILED DESCRIPTION OF THE CURRENT EMBODIMENTS

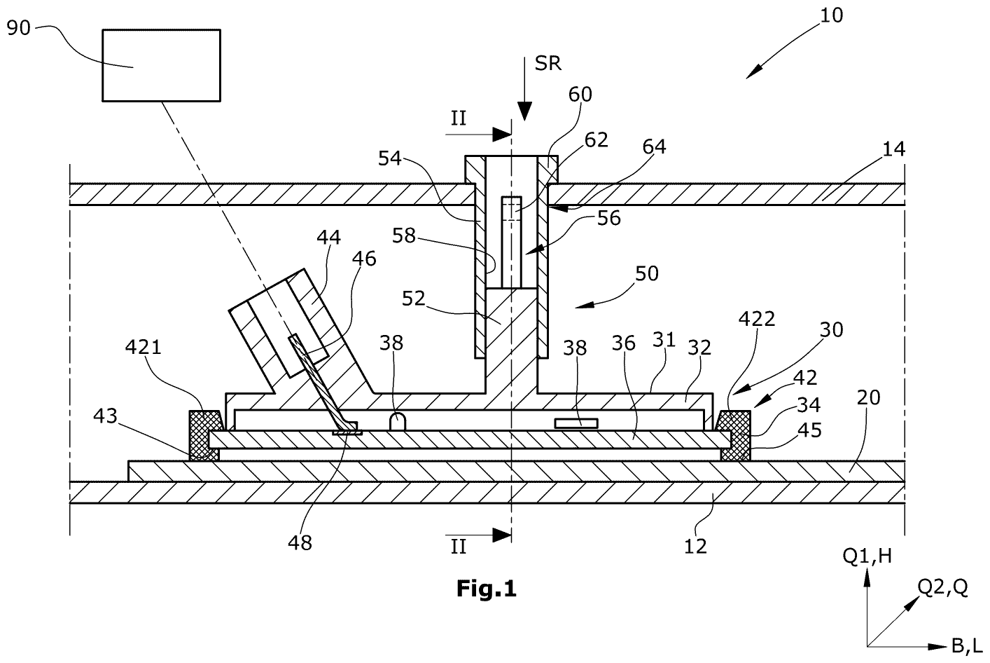

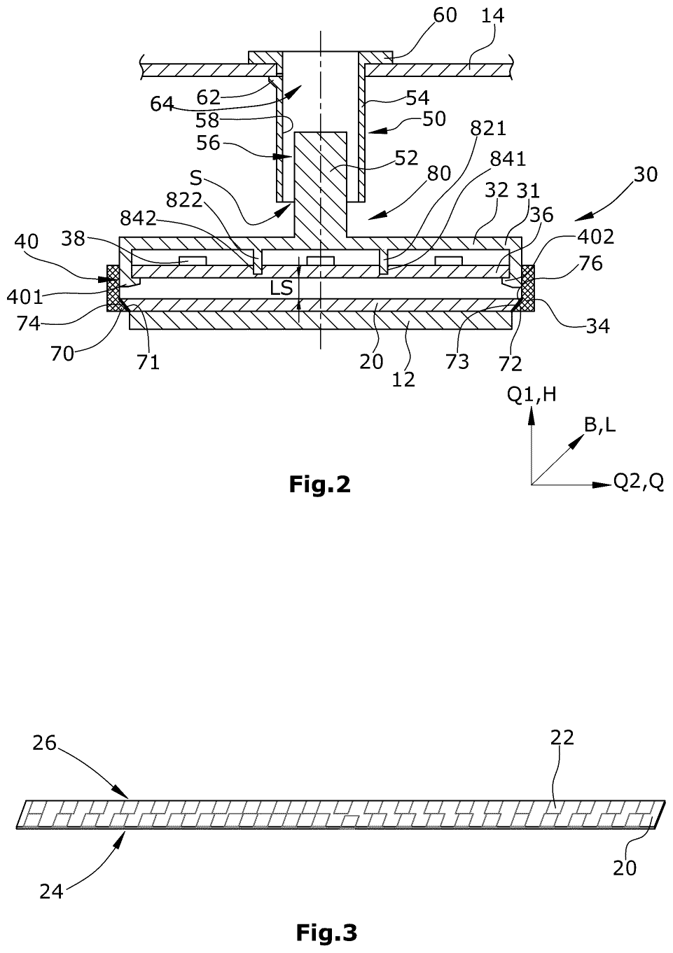

FIG. 1 and FIG. 2 show a vehicle system arrangement 10 comprising a first body 12 and a second body 14. For example, the first body 12 is a fixed vehicle seat guide which is mounted on a body shell of a motor vehicle, and the second body 14 is a vehicle seat guide rail which is connected to a vehicle seat and can be displaced together with the vehicle seat. The vehicle seat guide rail engages in the vehicle seat guide in such a manner that the vehicle seat guide rail and thus the vehicle seat is guided by the vehicle seat guide during an adjustment process, wherein the adjustment is carried out in particular by means of an electric drive unit.

In order to detect the position of the second body 14 relative to the first body 12, a scanning belt 20 is arranged on the first body 12 and a linear path sensor 30 is arranged on the second body 14, wherein the scanning belt 20 interacts with the linear path sensor 30 or is scanned by the linear path sensor 30, which is designed as an inductive sensor.

As shown in FIG. 3, the scanning belt 20 has two rows 24, 26 running parallel to one another, which have a plurality of scanning elements 22. The scanning elements 22 of the two rows 24, 26 are arranged offset to one another, i.e. the distance between the scanning elements 22 of the two rows 24, 26 deviates from one another. Using the vernier principle, the position of the second body 14 relative to the first body 12, i.e. the position of the vehicle seat, can be reliably and accurately determined by the linear path sensor 30.

The linear path sensor 30 has a housing 31 and a circuit board 36, wherein the housing 31 is made in particular of plastic. The circuit board 36 is disposed within the housing 31 and has the corresponding components 38 required to detect the scanning belt 20 and to determine the position of the second body 14 relative to the first body 12. The housing 31 comprises an upper part 32 and a lower part 34. The linear path sensor 30 is based in particular on an inductive measuring principle. One such linear path sensor based on the inductive measuring principle is the so-called CIPOS sensor from HELLA.

The upper part 32 is positively connected to the circuit board 36 via a latching connection 40, in that the upper part 32 has a plurality of latching elements 401, 402 which engage behind the circuit board 36. In the assembled state, the lower part 34 is arranged in portions on the latching elements 401, 402 engaging behind the circuit board 36 in such a manner that the latching elements 401, 402 are secured by the lower part 34 against loosening of the latching connection 40. For this purpose, the upper part 32 is mounted on the circuit board 36 before the lower part 34 is mounted on the circuit board 36.

The upper part 32 comprises a plug 44, which has a plurality of contact elements 46, via which the linear path sensor 30 can be connected to an evaluation unit 90. The contact elements 46 are designed as spring contact elements and have a resilient portion projecting into the interior of the housing 31, wherein the resilient portion is electrically coupled to a mating contact 48 of the circuit board 36 in a mounted state of the linear path sensor 30. Due to the embodiment of the contact elements 46 as spring contact elements, electrical contacting between the contact elements 46 and the mating contacts 48 is produced exclusively by the connection or latching of the upper part 32 to the circuit board 36, wherein the resilient portion of the contact elements 46 is deformed and thereby biased during the mounting of the upper part 32 to the circuit board 36, so that the contact elements 46 are pressed onto the mating contacts 48. In order to precisely align the upper part 32 relative to the circuit board 36 in all directions and thereby provide a reliable coupling between the contact elements 46 and the mating contacts 48, the upper part 32 additionally has a plurality of pins 821, 822 projecting in the direction of the circuit board 36, each of which engages in an opening 841, 842 of the circuit board 36. The pins 821, 822 and the openings 841, 842 form a plug-in connection 80.

The lower part 34 is also positively connected to the circuit board 36 via a latching connection 42. For this purpose, the lower part 34 has a plurality of latching elements 421, 422, which engage behind the circuit board 36. Here, the circuit board 36 rests against a shoulder 43 of the lower part 34 and is gripped by the latching elements 421, 422 on a side opposite the shoulder 43. The lower part 34 is designed like a frame in such a manner that an opening is provided both in the upper region, in which the upper part 32 is arranged, and in the lower region facing the scanning belt 20. Through the opening in the lower region, the scanning belt 20 can be scanned by the corresponding components arranged on the circuit board 36.

The lower part 34 also comprises a guide element 70, 72 on each side as viewed in the transverse direction of the vehicle Q, i.e. in the second transverse direction Q2, which serve to guide the linear path sensor 30 on the sensing element 20 during the displacement of the second body 14 relative to the first body 12 in the direction of movement B. The guide elements 70, 72 each have a sloped guide surface 71, 73 that tapers towards one another, each of which rests against a corresponding, sloping mating guide surface 74, 76 of the scanning belt 20 and slides along it during the adjustment process. This provides a dovetail-like guide for the linear path sensor 30 on the scanning belt 20, wherein the lower part 34 rests with a further sliding surface 45 against a side of the scanning belt 20 facing away from the first body 12 and slides along this during the adjustment process. Preferably, the dovetail-like guide of the linear path sensor 30 is at least slightly pretensioned in order to ensure that the lower part 34 is in permanent contact with the scanning belt 20.

A problem with position measurement by means of the linear path sensor 30 is that displacements transverse to the direction of movement B, i.e. in transverse directions Q1, Q2 or in relation to a vehicle coordinate system in the vertical direction of the vehicle H and in the transverse direction of the vehicle Q with a direction of movement B aligned in the longitudinal direction of the vehicle L, of the linear path sensor 30 relative to the scanning belt 20 lead to falsified sensor signals of the linear path sensor 30. It is also necessary for an air gap LS between the linear path sensor 30 and the scanning belt 20 to be as small as possible and the same in every position.

In order to avoid falsification of the sensor signals of the linear path sensor 30, the linear path sensor 30 is mounted on the second body 14 in such a manner that it can be displaced transversely to the direction of movement B, i.e. in both transverse directions Q1, Q2, wherein the linear path sensor 30 is fixedly mounted on the second body 14 in the direction of movement B. For this purpose, the linear path sensor 30 and the second body 14 are connected to one another via a plug-in connection device 50, wherein the plug-in direction is aligned in the first transverse direction Q1 or in the vertical direction of the vehicle H.

The plug-in connection device 50 is composed of a protrusion 52 formed on the upper part 32 of the housing 31 and an opening 56 with a circumferential surface 58, wherein the protrusion 52 engages in the opening 56. To provide the opening 56, a sleeve-like driver element 54 is arranged on the second body 14, which delimits the opening 56 by the inner circumferential surface, so that the inner circumferential surface of the driver element 54 forms the circumferential surface 58 of the opening 56.

The sleeve-like driver element 54 is positively connected to the second body 14. For this purpose, the second body 14 has a receiving opening 64 into which the driver element 54 is inserted. As a result, the driver element 54 is positively connected to the second body 14 in the direction of movement B and in the second transverse direction Q2. The driver element 54 is fixed to the second body 14 in the first transverse direction Q1, i.e. in the vehicle coordinate system in the vertical direction of the vehicle H, on the one hand by a radial protrusion 60 and on the other hand by a latching connection, wherein the driver element 54 has a resilient latching element 62. When mounting the driver element 54 on the second body 14, the driver element 54 is pushed through the receiving opening 64 until the radial protrusion 60 is in contact with the second body 14 in the longitudinal direction of the driver element 54 and the latching element 62 has already been passed over. The latching element 62 recedes when the driver element 54 is pushed through the receiving opening 64 and catches again when the latching element 62 is no longer radially loaded by the second body 14 due to the subsequent movement of the driver element 54. In the final assembled state of the driver element 54, this lies in the longitudinal direction against two sides of the second body 14 which are opposite to each other, i.e. by the radial protrusion 60 and the latching element 62, whereby the driver element 54 is fixed to the second body 14 in the vertical direction of the vehicle H.

In order to provide the driver function in the direction of movement B, i.e. in the longitudinal direction of the vehicle L, and the free movement in the transverse directions Q1, Q2, i.e. in the vertical direction of the vehicle H and in the transverse direction of the vehicle Q, the protrusion 52 lies directly against the circumferential surface 58 on both sides in the direction of movement B, glides along the circumferential surface 58 in the vertical direction of the vehicle H and is arranged with a gap S at a distance from the circumferential surface 58. The contact of the circumferential surface of the protrusion 52 with the circumferential surface 58 of the opening 56 is shown in FIG. 1. The gap S between the circumferential surface of the protrusion 52 and the circumferential surface 58 is shown in FIG. 2. As a result, the linear path sensor 30 is supported or guided transversely to the direction of movement B, i.e. in both transverse directions Q1, Q2, exclusively by the scanning belt 20, i.e. by the contact of the guide element 70, 72 with the scanning belt 20.

By such embodiment of the vehicle system arrangement 10, the linear path sensor 30 can be moved together with the second body 14 in the direction of movement, i.e. in the longitudinal direction of the scanning belt 20 and in the longitudinal direction of the vehicle L, wherein the predefined position of the linear path sensor 30 relative to the scanning belt 20 can be maintained reliably and in particular independently of manufacturing tolerances and other deviations, since in particular the deviations transverse to the direction of movement B which inevitably occur can be compensated. In this manner, the risk of falsified sensor signals from the linear path sensor 30 can be reduced.

### LIST OF REFERENCE NUMERALS

10 vehicle system arrangement
12 first body
14 second body
20 scanning belt
22 scanning elements
24 first row of scanning elements
26 second row of scanning elements
30 linear path sensor
31 housing
32 upper part
34 lower part
36 circuit board
38 components
40 latching connection
401 latching element
402 latching element
42 latching connection
421 latching element
422 latching element
43 shoulder
44 plug
45 sliding surface
46 contact element
48 mating contact
50 plug-in connection device
52 protrusion
54 driver element
56 opening
58 circumferential surface
60 radial protrusion
62 latching element
64 receiving opening
70 guide element
71 guide surface
72 guide element
74 mating guide surface
76 mating guide surface
80 plug connection
821 pin
822 pin
841 opening
842 opening
90 elevation unit
B direction of movement
H vertical direction of the vehicle
L longitudinal direction of the vehicle
LS air gap
Q transverse direction of the vehicle
Q1 first transverse direction
Q2 second transverse direction
S air gap
SR insertion direction

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A vehicle system arrangement, comprising:
a first body on which a scanning belt with a plurality of scanning elements is fixedly arranged;
a second body, which is displaceable in a direction of movement relative to the first body, wherein a linear path sensor is arranged on the second body, which interacts with the scanning belt; and
an evaluation unit which is configured to determine a linear position of the first body relative to the second body as a function of a sensor signal of the linear path sensor, wherein the linear path sensor is fixedly mounted on the second body in the direction of movement and is displaceably mounted on the second body transversely to the direction of movement.

2. The vehicle system arrangement of claim 1, wherein the linear path sensor is connected to the second body via a plug-in connection device, wherein a plug-in direction of the plug-in connection device is oriented transversely to the direction of movement.

3. The vehicle system arrangement of claim 2, wherein the plug-in connection device has a protrusion which is inserted into a corresponding opening, wherein the protrusion is mounted fixedly in the opening in the direction of movement and displaceably in a first transverse direction aligned transversely to the direction of movement, in such a manner that the protrusion bears on both sides against a circumferential surface of the opening in the direction of movement and glides on the circumferential surface of the opening.

4. The vehicle system arrangement of claim 2, wherein the plug-in connection device has a protrusion which is inserted into a corresponding opening, wherein the protrusion is mounted in such a manner that it can be displaced in a second transverse direction aligned transversely to the direction of movement, such that there is a gap in the second transverse direction between the protrusion and the circumferential surface of the opening.

5. The vehicle system arrangement of claim 4, wherein a sleeve-like driver element is provided on the second body or on the linear path sensor and is positively connected to the second body or the linear path sensor, wherein the driver element has the opening or forms the protrusion.

6. The vehicle system arrangement of claim 5, wherein the sleeve-like driver element has a radial protrusion and a latching element; and wherein the sleeve-like driver element is arranged in a receiving opening of the second body and is fixed in an insertion direction of the driver element via the radial protrusion and the latching element.

7. The vehicle system arrangement of claim 1, wherein the linear path sensor is guided on the scanning belt in the direction of movement.

8. The vehicle system arrangement of claim 1, wherein the linear path sensor has two guide elements which engage behind the scanning belt.

9. The vehicle system arrangement of claim 8, wherein the guide elements have a slope guide surface which tapers towards one another and which rest against a respective slope mating guide surface of the scanning belt.

10. The vehicle system arrangement of claim 9, wherein the scanning belt is chamfered on one end face.

11. The vehicle system arrangement of claim 1, wherein the linear path sensor has a housing with an upper part and a lower part, wherein a circuit board is latched to the lower part and the upper part is latched to the circuit board.

12. The vehicle system arrangement of claim 11, wherein the upper part has a plug, wherein resilient electrical contact elements are arranged on the upper part for making contact with a respective mating contact of the circuit board.

13. The vehicle system arrangement of claim 11, wherein the circuit board is positioned relative to the upper part via a plug-in connection.

14. The vehicle system arrangement of claim 1, wherein the linear path sensor is an inductive sensor.

15. The vehicle system arrangement of claim 1, wherein the first body is a fixed vehicle seat guide and the second body is a vehicle seat guide rail connected to the vehicle seat and displaceable with the vehicle seat.
